(19) United States
(12) Patent Application Publication
(10) Pub. No.: US 2024/0212086 A1
(43) Pub. Date: Jun. 27, 2024

(54) SYSTEMS AND METHODS FOR TRIAGING HIGH RISK MESSAGES

(71) Applicant: CRISIS TEXT LINE, New York, NY (US)

(72) Inventors: Ankit Gupta, New York, NY (US); Shayne Martin, New York, NY (US); Mateo Garcia, New York, NY (US); Shairi Turner-Davis, New York, NY (US)

(21) Appl. No.: 18/598,607

(22) Filed: Mar. 7, 2024

Related U.S. Application Data
(60) Provisional application No. 63/548,470, filed on Nov. 14, 2023.

(51) Int. Cl. G06Q 50/26; G06N 5/02

(52) U.S. Cl. CPC G06Q 50/265; G06N 5/02

(57) ABSTRACT

The present invention provides a system which comprises a database of previous interactions between help line users and help line responders. The database allows call response centers to review call interaction data and provide scores to individual users, real-time interactions, and call responders.

### I. FIELD OF THE INVENTION

The disclosure relates generally databases of help line communications and systems and methods of their use.

### II. BACKGROUND OF THE INVENTION

Data released from the World Health Organization and Centers for Disease Control and Prevention reveal increasing rates of depression and suicide across the United States and globally. The lack of good mental health care, as well as difficulty accessing affordable and effective resources and treatments, pose a serious threat to society. With the advent of social media, the public can connect with friends and family at an unprecedented scale and yet become increasingly disconnected emotionally from those friends and family, as well as society at large. The increased costs and lingering social stigmas associated with seeking mental health treatment may also serve as additional obstacles to those suffering, particularly to children and young adults, who are often reliant on the involvement of a parent or school official to obtain help.

It has also been observed that cellular phone users, and especially younger people, increasingly communicate via text messaging rather than by phone call. As used herein, the term “text messaging” is understood as any electronic communication by which real-time or nearly real-time communication is intended. Such real-time or nearly real-time communication is distinguished from other electronic communication, such as for example e-mail, and includes but is not limited to: short-message-service (SMS), iMessage™, and social media or other cross-platform messaging applications.

Help lines provide a safe, confidential and anonymous resource for individuals to seek immediate help during times of emotional crisis. In operation, a user dials a number or submits a text message to a help line provider—and waits for a response from a counselor or administrator associated with the help line.

### III. SUMMARY OF THE INVENTION

Call response centers, however, face several obstacles.

First, responders must generally be trained in real-time interactions with users. This means that help line responders, frequently volunteers, must face real users before they have substantial experience. This can result in a negative experience for both the user and the responder, but has nevertheless been unavoidable in training responders.

Second, calls are generally assigned agnostic to the intensity of interactions. Although calls may be escalated, the decision to do so is dependent on the help line responder and their subjective decision.

Third, calls are also generally assigned agnostic to the preferences of call line responders. This results in call line responders being asked to, at least initially, take calls which they are uncomfortable taking or less equipped to take.

The present invention provides a system and methods which comprise a database of previous interactions between help line users and help line responders. The database allows call response centers to review call interaction data and provide scores to individual users, real-time interactions, and call responders.

### Training of Help Line Responders

In aspects, the invention provides a system for training and assisting help line responders, comprising. Notably, the invention provides a database comprising: previous interactions between help line users and help line responders, the interactions comprising help line user communications and help line responder communications, and efficacy scores for help line responder communications within each previous interaction. The system further comprises a module developed from the database that provides simulated help line user communications to trainees; evaluate the effectiveness of help line responder communications; and/or provide recommended responses to help line responders. This allows for the training of help line responders, for example volunteers, without risking a negative interaction with a user as a result of real-time training.

The systems of the invention are critical in training the help line responders to assist users dealing with a crisis. The training methods of the systems provide efficient and economic methods for training of the users.

In certain embodiments, the machine learning module for training help line responders is configured to output simulated help line user communications to a trainee, and evaluate the effectiveness of help line responder trainee communications to the simulated help line user communications. This evaluation is crucial in providing feedback to the help line responder to optimize the training regimen for the help line responders. In certain embodiments, the systems of the invention are cognizant that the simulated conversations used for training the help line responders are not the communications between the current or past help line users and the help line responders. In certain embodiments, the machine learning module used for training of the help line responders are not connected to the database that stores the conversations between the help line users and the help line responders.

In certain embodiments, the machine learning module is configured to: evaluate the effectiveness of help line responder communications to help line user communications; and provide recommended responses for help line responders to provide to help line users' communications, in real-time. Thus, the learning module would be acting as an assistant for the help line responder to assist the user by relying on the past responses.

### Intensity Escalation and Assignment

Users of help lines are generally unable to optimally pair the help line responders with the user. More specifically, the help lines struggle with developing systems that optimally leverage the expertise and diversity of experience on their help line responders to provide the best help possible to the user. In other words, help line responders are paired with the user based on their place in queue, current workload, and the risk factors that may be nominally extracted from the content of the text message from the user. This approach is problematic because significant harm (and even death) may occur when a user in urgent crisis is not timely responded to by an optimally trained crisis counselor. Such systems pose serious risks to users in crisis. The approaches for pairing of the help line responders with the help line users are described in U.S. Pat. No. 10,897,537, which is incorporated by reference herein in its entirety.

Systems and methods are therefore needed, which automatically prioritize users contacting a help line system in accordance with an evaluated level of risk to each user, respectively.

The systems of the invention solve this problem by optimally pairing the help line responders with the users based on a variety of factors. Without being intended to be limiting, the systems provided herein leverage machine learning and automation, which relies on a number of factors, including the history of the user with the help line, the messages received by the help line from the user, help line responder seniority, help line responder area of expertise and training, and helpline responder preferences, to optimally pair the help line responder with the users looking for support and help by calling the help line. In certain aspects, the systems of the invention triage the user requests, and in real-time, change the risk associated with a certain user/help line responder communication to achieve optimal utilization of resources and generating maximum benefit for the user.

In certain aspects, the invention provides optimized and efficient systems for assignment of help line responders to users' request. In certain embodiments, the system relies on previous interactions between the help line users requesting assistance and the responses from the help line responders and the users. In certain embodiments, the invention provides a system of risk assessment for a particular users' request. In certain embodiments, the invention provides a system for risk assessment comprising a database, wherein the database comprises previous interactions between help line users and help line responders, the interactions comprising help line user communications and help line responder communications. The said database further comprises intensity scores for previous interactions based on help line user communication and help line responder communications. The system for intensity escalation and risk assessment further comprises a machine learning module trained on the database, wherein the machine learning module is configured to assign an intensity score to interactions based on the user communications and/or responder communications.

In certain embodiments, the system for risk assignment and escalation is configured to provide an alert to a help line responder and/or supervisor of the help line responder based on an assigned intensity score. This is beneficial since the system will provide real time alerts to the supervisor of a help line responder or a help line responder about a situation where an intervention from the help line responder or a supervisor of the help line responder will be warranted. This enables the system to place higher confidence in managing the instances where an input is required by the help line responder or the supervisor of a help line responder. Efficient utilization of the human involvement in dealing with the users' request is an important aspect of the invention in providing enhanced service to the users of the system.

In certain embodiments, the system for risk assignment and escalation further comprises an assignment module which receives help line responder preferences regarding interaction intensity. In certain embodiments, the assignment module receives help line responder preferences in real time. In certain embodiments, help line responder preferences may be automatically generated by the system.

In certain embodiments, when the system receives help line user communications then the assignment module receives an intensity score for the interaction from the machine learning module based on the help line user communications and assigns the help line user to a help line responder based on the help line responder's preferences.

In certain embodiments, the system for risk assignment and escalation further comprises an assignment module which receives help line responder attributes. The help responder attributes can be selected from a variety of factors for the help line responder. The help line responder attributes may be selected from the group consisting of: professional clinical social work or psychological experience or supervisory experience or staff or volunteer experience. The utilization of these factors in making the risk assignment and escalation determination allows the system to account for the individual traits of the help line responder. For example, a certain help line responder may be relatively inexperienced and may not be suitably trained to deal with high risk situations or conversations. The system will account for such factors to evaluate the risk assessment. In contrast, in certain embodiments, the system will attempt to assign help line responders with higher experience in dealing with high intensity situations to the interactions with higher risk assignment. This is beneficial for optimal assignment of the help line responders and their supervisors to deal with high-risk situations.

In certain embodiments, the system is configured to analyze a plurality of electronic messages from users' devices, and prioritize users in a queue for responses from help line responders based upon their assigned intensity score. In certain embodiments, the configuration involves the use of heuristics-based algorithm in connection with the machine learning section trained on analyzing the conversations.

### Preference Based Assignment

In certain aspects, the invention provides a system for help line assessment, wherein the system comprises a database comprising previous interactions between help line users and help line responders, the interactions comprising help line user communications and help line responder communications; categories for help line interactions; categorizations into the categories for previous interactions based on the help line user communications, help line user inputs, help line responder communications, and help line responder inputs; and a machine learning module trained on the database, the machine learning module configured to assign interactions into one or more categories based on user communications and/or responder communications. In certain embodiments, the user inputs may include the actual content from the conversation with the user. In certain embodiments, the user responses may include input received from the user in a pre- or post-conversation survey with the user. In certain embodiments, the user input may include any additional input provided by the user regarding the experience with the help line responder or their experience and/or expectations in reaching out the help line.

In certain embodiments, the help line responder inputs may include the actual content from the conversation with the user. In certain embodiments, the help line responder responses may include input received from the user in a pre- or post-conversation survey with the user. In certain embodiments, the help line responder input may include any additional comments or observations regarding the experience with the conversation with the user and any potential improvements needed to the protocols to improve user experience for the help line.

In certain embodiments, the system further comprises an assignment module which receives help line responder preferences regarding categories for help line interactions. It is beneficial to have the help line responder preferences to ensure optimal assignment of the users' request to individual help line responders.

In certain embodiments, the assignment module receives help line responder preferences in real time. In certain embodiments, the system receives help line user communications and then the assignment module receives one or more categories for the interaction from the machine learning module based on the help line user communications and assigns the help line user to a help line responder based on help line responder preferences. In certain embodiments, categories for help line interactions include internal characterizations selected from the group consisting of prank, testing, non-engaged/nonresponsive, third party, or international, emotional and mental health crises such as anxiety, depression, eating disorders, emotional abuse, gun violence, loneliness, suicide, and self-harm. For clarity, this list is non-exhaustive. A person of ordinary skill in the art would recognize that there may be additional characterizations that may be included to increase the effectiveness of the system in providing optimal experience of the users and the help line responders.

In certain embodiments, the system further comprises an assignment module which receives help line responder attributes.

In certain embodiments, the system receives help line user communications then the assignment module receives one or more categories for the interaction from the machine learning module based on the help line user communications and assigns the help line user to a help line responder based on help line responder attributes. In certain embodiments, the help line responder attributes include clinical experience, supervisory experience, and experience within a category. This is particularly beneficial in optimally pairing the help line responders with the help line users to achieve optimal outcomes in their interactions.

### IV. BRIEF DESCRIPTION OF THE DRAWINGS

FIG. 1 schematically illustrates a system in accordance with one or more aspects of the invention.

FIG. 2 schematically illustrates a system architecture in accordance with one or more aspects of the invention.

### V. DETAILED DESCRIPTION

The invention provides systems for training first line responders to assist the users to deal with the crises that they are facing. In certain aspects, the system provides methods of triaging conversations and assigning them to the help line responders in an optimal way.

The features and advantages will become apparent from the following more detailed description, taken in conjunction with the accompanying drawings, which illustrate, by way of example, the principles of the presently disclosed invention.

The above-described drawing figures illustrate the disclosed invention in at least one of its embodiments, which invention is further defined in detail in the following description. Those having ordinary skill in the art may be able to make alterations and modifications to the invention described herein without departing from its spirit and scope. While the invention is susceptible of embodiment in many different forms, there is shown in the drawings and will herein be described in detail at least one preferred embodiment of the invention, with the understanding that the disclosure is to be considered as an exemplification of the principles of the invention and is not intended to limit the broad aspect of the invention to the embodiments illustrated. Therefore, it should be understood that what is illustrated is set forth only for the purposes of example and should not be taken as a limitation on the scope of the present invention.

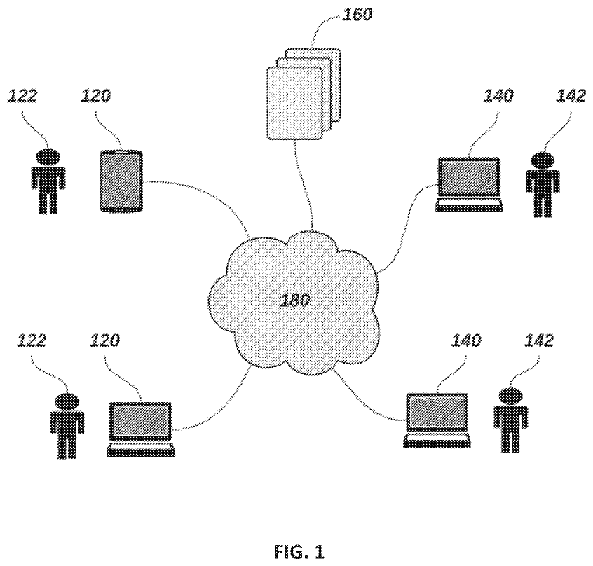

FIG. 1 illustrates an example system 100 in accordance with one or more aspects of the disclosure. The system may represent at least a portion of an IT environment of a help line service provider, which is configured to automatically prioritize users contacting the crisis help line provider in accordance with an evaluated level of risk to each user.

The system may include one or more user devices 120, each respectively associated with a user 122, one or more counselor devices 140, each respectively associated with a counselor or other administrator 142, a help line server system 160, and a network 180 that operatively couples the components of the system.

The crisis line server system may include a plurality of computers and/or computing devices, such as server computers and storage devices. The server computers may include one or more processors, memories, interfaces, and/or displays, and may be configured to communicate with other system components via the network. The server computers may be rack mounted on a network equipment rack and/or located, for instance, in a data center. In one example, the server computers may use the network to serve the requests of programs executed on counselor devices, user devices, and/or storage devices.

The storage devices may be configured to store large quantities of data and/or information. For example, the storage devices may be a collection of storage components, or a mixed collection of storage components, such as ROM, RAM, hard-drives, solid-state drives, removable drives, network storage, virtual memory, cache, registers, etc. Each storage device may also be configured so that other components of the system may access it via the network.

The counselor device and the user device may each include different types of components associated with a computer and/or computing device, such as one or more processors, memories, instructions, data, displays, and interfaces—and may be configured to communicate with other components of the system via network. The devices may be mobile (e.g., laptop computer, tablet computer, smartphone, PDA, etc.) or stationary (e.g., desktop computer, etc.).

The processor may instruct the components thereof to perform various tasks based on the processing of information and/or data that may have been previously stored or have been received, such as instructions and/or data stored in the memory. The processor may be a standard processor, such as a central processing unit (CPU), or may be a dedicated processor, such as an application-specific integrated circuit (ASIC), or a field programmable gate array (FPGA).

The memory stores at least instructions and/or data that can be accessed by the processor. For example, the memory may be hardware capable of storing information accessible by the processor, such as a ROM, RAM, hard-drive, CD-ROM, DVD, write-capable, read-only, etc. The set of instructions may be included in software that can be implemented on the respective device. It should be noted that the terms “instructions,” “steps,” “algorithm,” and “programs” may be used interchangeably. Data can be retrieved, manipulated or stored by the processor in accordance with the set of instructions or other sets of executable instructions. The data may be stored as a collection of data.

The display may be any type of device capable of communicating data to a user, such as a liquid-crystal display (“LCD”) screen, a plasma screen, etc. The interface allows the counselor or other administrator to communicate with the device—and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface “GUI,” etc.).

The network may be any type of network, wired or wireless, configured to facilitate the communication and transmission of data, instructions, etc. from one component to another component of the network. For example, the network may be a local area network (LAN) (e.g., Ethernet or other IEEE 802.03 LAN technologies), Wi-Fi (e.g., IEEE 802.11 standards, wide area network (WAN), virtual private network (VPN), global area network (GAN), any combination thereof, or any other type of network.

It is to be understood that the network configuration illustrated in FIG. 1 serves only as an example and is thus not limited thereto. The system, for instance, may include numerous other components connected to the network, may include more than one of each network component, may be connected to other networks, and may comprise multiple interconnected networks.

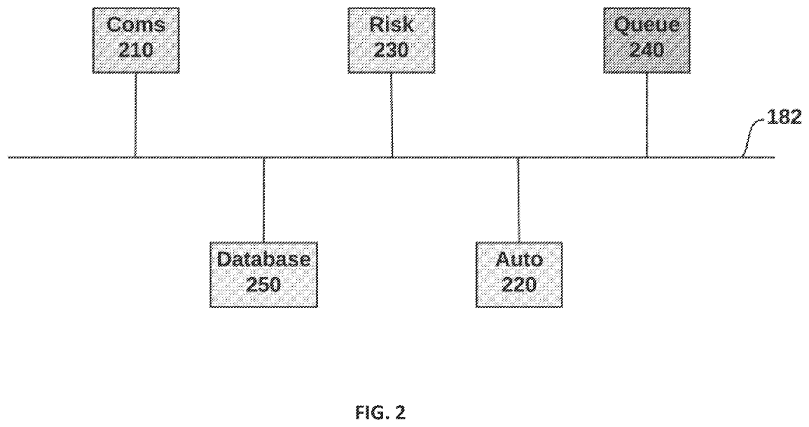

FIG. 2 illustrates one embodiment of system architecture 200 for providing a help line service provider that automatically prioritizes users contacting the help line provider in accordance with an evaluated level of risk to each user. In general, the system architecture maintains a queue of text message conversations that are prioritized according to an associated dynamic risk indicator generated via an artificial intelligence model trained with historical conversations.

The system architecture includes a communications module 210, an auto-response module 220, a risk assessment module 230, a queue management module 240, and a database 250, each operatively and communicatively coupled via system network 182. Each module may include one or more software components or parts of programs that include one or more routines or sub-routines that, when executed by one or more computers, implement the operations described herein with reference to the specific module. Each module may also, in whole or in part, comprise one or more web-applications, including attendant web-servers and databases, which implement the operations described herein.

The communications module is generally configured to establish and maintain an operative communication link between user devices and the help line server system, as well as between user devices and counselor devices, via the help line server system, in accordance with the principles discussed herein. As such, the communications module operates as an intermediary between the help line server system and/or counselor devices, at one end, and the user devices, at the other end.

In at least one embodiment, the communications module is configured to receive electronic communications (“e-coms”) 410, including text and/or voice messages, from the user devices and the counselor devices via the network, and to manage e-coms relayed by the communications module between the user devices, counselor devices and the help line server system. The e-coms may be received directly and/or indirectly via a service provider, e.g., cellular service providers, social media and web-communication platforms, and other messaging platforms. Accordingly, the communications module may utilize existing messaging platforms and platform technologies, including but not limited to Twilio or various social media messaging applications.

The communications module may associate one or more e-coms with an electronic conversation 420 such that the conversation forms a record of e-coms received from and/or sent to the user device. The conversation may in turn be stored in the database in association with the user device sending and/or receiving the e-coms forming the conversation. In some embodiments, the conversation may also be associated with the device(s) sending and/or receiving the e-coms forming the conversation.

### Training of Help Line Responders

Help lines typically rely on a lot of help line responders to assist users in dealing with the respective crisis. Training the number of help line responders to provide optimal support to the users presents challenges.

In certain aspects, the invention provides a system for training and assisting help line responders, comprising: a database comprising: previous interactions between help line users and help line responders, the interactions comprising help line user communications and help line responder communications, and efficacy scores for help line responder communications within each previous interaction. The system further comprises a machine learning module trained on the database, the machine learning module configured to: output simulated help line user communications to trainees; evaluate the effectiveness of help line responder communications; and/or provide recommended responses to help line responders. The systems of the invention are critical in training the help line responders to assist users dealing with crisis. The training methods of the systems provide efficient and economic methods for training of the users.

In certain embodiments, the machine learning module for training help line responders is configured to: output simulated help line user communications to a trainee, and evaluate the effectiveness of help line responder trainee communications to the simulated help line user communications. This evaluation is crucial in providing feedback to the help line responder to optimize the training regimen for the help line responders. In certain embodiments, the systems of the invention are cognizant that the simulated conversations used for training the help line responders are not the communications between the current or past help line users and the help line responders. In certain embodiments, the machine learning module used for training of the help line responders are not connected to the database that stores the conversations between the help line users and the help line responders.

In certain embodiments, the machine learning module is configured to: evaluate the effectiveness of help line responder communications to help line user communications; and provide recommended responses for help line responders to provide to help line users' communications, in real-time. Thus, the learning module would be acting as an assistant for the help line responder to assist the user by relying on the past responses.

### Intensity Escalation and Assignment

The users of help lines are generally responded to in a manner that does not assign priority to the severity of crises being suffered by the users requesting such services.

The methods of present invention provide systems of triaging the requests from the users of the system to assign priority orders to the requests from the users. In certain aspects, the invention provides system for training and assisting help line responders. In certain aspects of the invention, the invention provides machine learning based approaches for training the help line responders to assist users of the system. The invention further provides that the methods of the invention provide methods of assessing risk for each conversation by assigning risk scores. The system further analyzes the preferences of the counselors and factors that in the assignment of counselors to the users to deal with the crises. The several aspects of the invention are explained below.

The disclosure provides for systems and methods that automatically prioritize users contacting a crisis hotline system in accordance with an evaluated level of risk to each user, respectively.

It has been observed that cellular phone users, and especially younger people, increasingly communicate via text messaging rather than by phone call. As used herein, the term “text messaging” is understood as any electronic communication by which real-time or nearly real-time communication is intended. Such real-time or nearly real-time communication is distinguished from other electronic communication, such as for example e-mail, and includes but is not limited to: short-message-service (SMS), iMessage™, and social media or other cross-platform messaging applications.

Help lines provide a safe, confidential and anonymous resource for individuals to seek immediate help during times of emotional crisis. In operation, a user dials a number or submits a text message to a help line provider—and waits for a response from a counselor or administrator associated with the help line.

It is problematic, however, that users of help lines are generally unable to optimally pair the help line responders with the user. More specifically, the help lines struggle with developing systems that optimally leverage the expertise and diversity of experience on their help line responders to provide the best help possible to the user. In other words, help line responders are paired with the user based on the user's place in a queue, current workload, and the risk factors that may be nominally extracted from the content of the text message from the user. This approach is problematic because significant harm may occur when a user in urgent crisis is not timely responded to by an optimally trained crisis counselor. The approaches for pairing of the help line responders with the help line users are described in U.S. Pat. No. 10,897,537, which is incorporated by reference herein in its entirety.

Systems and methods are therefore needed, which automatically prioritize users contacting a help line system in accordance with an evaluated level of risk to each user, respectively.

The systems of the invention solve this problem by optimally pairing the help line responders with the users based on a variety of factors. Without being intended to be limiting, the systems provided herein leverage machine learning and automation, which relies on a number of factors, including the history of the user with the help line, the messages received by the help line from the user, help line responder seniority, help line responder area of expertise and training, and helpline responder preferences, to optimally pair the help line responder with the users looking for support and help by calling the help line. In certain aspects, the systems of the invention triage the user requests, and in real-time, change the risk associated with a certain user/help line responder communication to achieve optimal utilization of resources and generating maximum benefit for the user.

In certain aspects, the invention provides optimized and efficient systems for assignment of help line responders to users' request. In certain embodiments, the system relies on previous interactions between the help line users requesting assistance and the responses from the help line responders and the users. In certain embodiments, the invention provides a system of risk assessment for a particular users' request. In certain embodiments, the invention provides a system for risk assessment comprising a database, wherein the database comprises previous interactions between help line users and help line responders, the interactions comprising help line user communications and help line responder communications. The said database further comprises intensity scores for previous interactions based on help line user communication and help line responder communications. The system for intensity escalation and risk assessment further comprises a machine learning module trained on the database, wherein the machine learning module is configured to assign an intensity score to interactions based on the user communications and/or responder communications.

In certain embodiments, the system for risk assignment and escalation is configured to provide an alert to a help line responder and/or supervisor of the help line responder based on an assigned intensity score. This is beneficial since the system will provide real time alerts to the supervisor of a help line responder or a help line responder about a situation where an intervention from the help line responder or a supervisor of the help line responder will be warranted. This enables the system to place higher confidence in managing the instances where an input is required by the help line responder or the supervisor of a help line responder. Efficient utilization of the human involvement in dealing with the users' request is an important aspect of the invention in providing enhanced service to the users of the system.

In certain embodiments, the system for risk assignment and escalation further comprises an assignment module which receives help line responder preferences regarding interaction intensity. In certain embodiments, the assignment module receives help line responder preferences in real time. In certain embodiments, help line responder preferences may be automatically generated by the system.

In certain embodiments, when the system receives help line user communications then the assignment module receives an intensity score for the interaction from the machine learning module based on the help line user communications and assigns the help line user to a help line responder based on the help line responder's preferences.

In certain embodiments, the system for risk assignment and escalation further comprises an assignment module which receives help line responder attributes. The help responder attributes can be selected from a variety of factors for the help line responder. The help line responder attributes may be selected from the group consisting of: professional clinical social work or psychological experience or supervisory experience or staff or volunteer experience. The utilization of these factors in making the risk assignment and escalation determination allows the system to account for the individual traits of the help line responder. For example, a certain help line responder may be relatively inexperienced and may not be suitably trained to deal with high risk situations or conversations. The system will account for such factors to evaluate the risk assessment. In contrast, in certain embodiments, the system will attempt to assign help line responders with higher experience in dealing with high intensity situations to the interactions with higher risk assignment. This is beneficial for optimal assignment of the help line responders and their supervisors to deal with high-risk situations.

In certain embodiments, the system is configured to analyze a plurality of electronic messages from users' devices, and prioritize users in a queue for responses from help line responders based upon their assigned intensity score. In certain embodiments, the configuration involves the use of heuristics-based algorithm in connection with the machine learning section trained on analyzing the conversations.

### Preference Based Assignment

In certain aspects, the invention provides a system for help line assessment, wherein the system comprises a database comprising previous interactions between help line users and help line responders, the interactions comprising help line user communications and help line responder communications; categories for help line interactions; categorizations into the categories for previous interactions based on the help line user communications, help line user inputs, help line responder communications, and help line responder inputs; and a machine learning module trained on the database, the machine learning module configured to assign interactions into one or more categories based on user communications and/or responder communications. In certain embodiments, the user inputs may include the actual content from the conversation with the user. In certain embodiments, the user responses may include input received from the user in a pre- or post-conversation survey with the user. In certain embodiments, the user input may include any additional input provided by the user regarding the experience with the help line responder or their experience and/or expectations in reaching out the help line.

In certain embodiments, the help line responder inputs may include the actual content from the conversation with the user. In certain embodiments, the help line responder responses may include input received from the user in a pre- or post-conversation survey with the user. In certain embodiments, the help line responder input may include any additional comments or observations regarding the experience with the conversation with the user and any potential improvements needed to the protocols to improve user experience for the help line.

In certain embodiments, the system further comprises an assignment module which receives help line responder preferences regarding categories for help line interactions. It is beneficial to have the help line responder preferences to ensure optimal assignment of the users' request to individual help line responders.

In certain embodiments, the assignment module receives help line responder preferences in real time. In certain embodiments, the system receives help line user communications and then the assignment module receives one or more categories for the interaction from the machine learning module based on the help line user communications and assigns the help line user to a help line responder based on help line responder preferences. In certain embodiments, categories for help line interactions include internal characterizations selected from the group consisting of prank, testing, non-engaged/nonresponsive, third party, or international, emotional and mental health crises such as anxiety, depression, eating disorders, emotional abuse, gun violence, loneliness, suicide, and self-harm. For clarity, this list is non-exhaustive. A person of ordinary skill in the art would recognize that there may be additional characterizations that may be included to increase the effectiveness of the system in providing optimal experience of the users and the help line responders.

In certain embodiments, the system further comprises an assignment module which receives help line responder attributes.

In certain embodiments, the system receives help line user communications then the assignment module receives one or more categories for the interaction from the machine learning module based on the help line user communications and assigns the help line user to a help line responder based on help line responder attributes. In certain embodiments, the help line responder attributes include clinical experience, supervisory experience, and experience within a category. This is particularly beneficial in optimally pairing the help line responders with the help line users to achieve optimal outcomes in their interactions.

### Machine Learning Systems

Aspects of the invention benefit from the use of machine learning systems, which may be trained on the databases of the invention to assist responders and users.

Any suitable machine learning system may be used and trained from databases of the invention. For example, the machine learning systems may learn in a supervised manner, an unsupervised manner, a semi-supervised manner, or through reinforcement learning.

In supervised learning models, the machine learning system is given training data categorized as input variables paired with output variables from which to learn patterns and make inferences in order to generate a prediction on previously unseen test data. Supervised models replicate an identified mapping system and recognize and respond to patterns in data without explicit instructions. Supervised models are advantageous for performing classification tasks, in which data inputs are separated into categories. Supervised models are also advantageous for regression tasks, in which the output variable is a real value, such as a price or a volume. The accuracy of a supervised model is easy to evaluate, because there is a known output variable to which the model is optimizing.

In an unsupervised model or autonomous model, the machine learning system is only given input training data without paired output data from which to identify patterns autonomously. Unsupervised models identify underlying patterns or structures in training data to make predictions for test data. Unsupervised models are advantageous for clustering data, anomaly detection, and for independently discovering rules for data. The accuracy of unsupervised models is harder to evaluate because there is no predefined output variable to which the system is optimizing. Autonomous models may employ periods of both supervised and unsupervised learning in order to optimize predictions.

In semi-supervised models, the machine learning system is given training data comprising input variables, with output variable pairs available for only a limited pool of the input variables. The model uses the input variables with known output variables and the remaining input training data to learn patterns and make inferences in order to generate a prediction on previously unseen test data. A semi-supervised model may query the user for additional paired output data based on unlabeled data.

In a reinforcement learning model, the machine learning system is given neither input variables nor output variables. Rather, the model provides a “reward” condition and then seeks to maximize the cumulative reward condition by trial and error. A common reinforcement learning model is a Markov Decision Process.

A common supervised learning model is a “decision tree.” Decision trees are non-parametric supervised learning models that use simple decision rules to infer a classification for test data from the features in the test data. In classification trees, test data take a finite set of values, or classes, whereas in regression trees, the test data can take continuous values, such as real numbers. Decision trees have some advantages in that they are simple to understand and can be visualized as a tree starting at the root (usually a single node) and repeatedly branch to the leaves (multiple nodes) that are associated with the classification. See Criminisi, 2012, Decision Forests: A unified framework for classification, regression, density estimation, manifold learning and semi-supervised learning, Foundations and Trends in Computer Graphics and Vision 7(2-3):81-227, incorporated by reference.

Another supervised learning model is a “support-vector machine” (SVM) or “support-vector network.” SVMs are supervised learning models for classification and regression problems. When used for classification of new data into one of two categories, such as having a disease or not having a disease, an SVM creates a hyperplane in multidimensional space that separates data points into one category or the other. Although the original problem may be expressed in terms that require only finite dimensional space, linear separation of data between categories may not be possible in finite dimensional space. Consequently, multidimensional space is selected to allow construction of hyperplanes that afford clean separation of data points. See Press, W.H. et al., Section 16.5. Support Vector Machines. Numerical Recipes: The Art of Scientific Computing (3rd ed.). New York: Cambridge University (2007), incorporated herein by reference. Where output variables are unavailable for input variables in the training data, SVMs can be designed as unsupervised learning models using support vector clustering. See Ben-Hur, 2001, Support Vector Clustering, J Mach Learning Res 2:125-137, incorporated by reference.

Some models rely on clustering training data and test data to find patterns and make predictions. A “k-nearest neighbor” (k-NN) model is a non-parametric supervised learning model for classification and regression problems. A k-nearest neighbor model assumes that similar data exists in close proximity, and assigns a category or value to each data point based on the k nearest data points. k-NN models may be advantageous when the data has few outliers and can be defined by homogeneous features. A common unsupervised learning model that uses clustering is a “k-means” clustering model. A k-means model looks to find clusters of data in input data and test data. K-means models are advantageous when a defined number of clusters are known to exist in the data and are also advantageous when the test data has few outliers and can be defined homogeneous features. Additional models that cluster training data include, for example, farthest-neighbor, centroid, sum-of-squares, fuzzy k-means, and Jarvis-Patrick clustering.

Bayesian algorithms can also be used to find patterns in training and test data to make predictions. Bayesian networks are probabilistic graphical models that represent a set of random variables and their conditional dependencies via directed acyclic graphs (DAGs). The DAGs have nodes that represent random variables that may be observable quantities, latent variables, node unknown parameters or hypotheses. Edges represent conditional dependencies; nodes that are not connected represent variables that are conditionally independent of each other. Each is associated with a probability function that takes, as input, a particular set of values for the node's parent variables, and gives (as output) the probability (or probability distribution, if applicable) of the variable represented by the node.

Regression analysis is another statistical process that can be used to find patterns in training and test data to make predictions. It includes techniques for modeling and analyzing relationships between a multiple variables. Specifically, regression analysis focuses on changes in a dependent variable in response to changes in single independent variables. Regression analysis can be used to estimate the conditional expectation of the dependent variable given the independent variables. The variation of the dependent variable may be characterized around a regression function and described by a probability distribution. Parameters of the regression model may be estimated using, for example, least squares methods, Bayesian methods, percentage regression, least absolute deviations, nonparametric regression, or distance metric learning.

Trained machine learning models can become “stable learners.” A stable learner is a model that is less sensitive to perturbation of predictions based on new training data. Stable learners can be advantageous where test data is stable, but can be less advantageous where the system needs to continually improve performance to accurately predict new test data.

### Ensembles

Several machine learning system types can be combined into a final predictive models known as ensembles. Ensembles can be divided into two types, homogenous ensembles and heterogeneous ensembles. Homogenous ensembles combine multiple machine learning models of the same type. Heterogeneous ensembles combine multiple machine learning models of different types. Ensembles can provide the advantage of being more accurate than any of the individual member models (“members”) in the ensemble. The number of members combined in an ensemble may impact the accuracy of a final prediction. Accordingly, it is advantageous to determine the optimal number of members when designing an ensemble system.

Ensembles may combine or aggregate outputs from individual members using “voting”-type methods for classification systems and “averaging”-type methods for regression systems.

In a “majority voting” method, each member makes a prediction for test data and the prediction that receives more than half of the votes is the final output for the ensemble. If none of the predictions receives more than half of the votes, it may be determined that the ensemble is unable to make a stable prediction. In a “plurality voting” method the most voted prediction, even if receiving less than half of the votes, may be considered the final output for the ensemble. In a “weighted voting” method, the votes of more accurate members are multiplied by a weight afforded each member based on its accuracy.

In a “simple averaging” method, each member makes a prediction for test data and the average of the outputs is calculated. This method reduces overfit and can be advantageous in creating smoother regression models. In a “weight averaging” method, the prediction output of each member is multiplied by a weight afforded each member based on its accuracy. Voting methods, averaging methods, and weighted methods can be combined to improve the accuracy of ensembles.

Members within an ensemble can each be trained independently or new members can be trained utilizing information from previously trained members. In a “parallel ensemble”, the ensemble seeks to provide greater accuracy than individual members by exploiting the independence between members, for example, by training multiple members simultaneously and aggregating the outputs from members. In “sequential ensemble systems”, the ensemble seeks to provide greater accuracy than individual members by exploiting the dependence between members, for example, by utilizing information from a first member to improve the training of a second member and weighting outputs from members.

Overall accuracy for ensembles can also be optimized by using ensemble meta-algorithms, for example a “bagging” algorithm to reduce variance, a “boosting” algorithm to reduce bias, or a “stacking” algorithm to improve predictions.

Boosting algorithms reduce bias and can be used to improve less accurate, or “weak learning” models. A member may be considered a “weak learning” model if it has a substantial error rate, but its performance is non-random, for example an error rate of 0.5 for binary classifications. Boosting algorithms incrementally build the ensemble by training each member sequentially with the same training data set, examining prediction errors for test data, and assigning weights to training data based on the difficulty for members to make an accurate prediction. In each sequential member trained, the algorithm emphasizes training data that previous members found difficult. Members are then weighted based on the accuracy of their prediction outputs in view of the weight applied to their training data. The predictions from each member may be combined by weighted voting-type or weighted averaging-type methods. Boosting algorithms are advantageous when combining multiple weak learning models. Boosting algorithms may, however, result in over-fitting test data to training data.

Examples of boosting algorithms include AdaBoost, gradient boosting, eXtreme Gradient Boost (XGBoost). See Freund, 1997, A decision-theoretic generalization of on-line learning and an application to boosting, J Comp Sys Sci 55:119; and Chen, 2016, XGBoost: A Scalable Tree Boosting System, arXiv:1603.02754, both incorporated by reference.

Bagging algorithms or “bootstrap aggregation” algorithms reduce variance by averaging together multiple estimates from members. Bagging algorithms provide each member with a random sub-sample of a full training data set, with each random sub-sample known as a “bootstrap” sample. In the bootstrap samples, some data from the training data set may appear more than once and some data from the training data set may not be present. Because sub-samples can be generated independently from one another, training can be done in parallel. The predictions for test data from each member are then aggregated, such as by voting-type or averaging-type methods.

An example of a bagging algorithm that may be utilized is a “random forests”. In a random forest the ensemble combines multiple randomized decision tree models. Each decision tree model is trained from a bootstrap sample from a training set. The training set itself may be a random subset of features from an even larger training set. By providing a random subset of the larger training set at each split in the learning process, spurious correlations that can results from the presence of individual features that are strong predictors for the response variable are reduced. By averaging predictions for test data, variance of the ensemble decreases resulting in an improved prediction. Random forests may autonomous models and may include periods of both supervised and unsupervised learning. Bagging may be less advantageous in optimizing an ensemble combining stable learning systems, since stable learning systems tend provide generalized outputs with less variability over the bootstrap samples. See Breiman, 2001, Random Forests, Machine Learning 45:5-32, incorporated by reference.

Stacking algorithms or “stacked generalization” algorithms improve predictions by using a meta-machine learning model to combine and build the ensemble. In stacking algorithms, base member models are trained with a training dataset and generate as an output a new dataset. This new dataset is then used as a training dataset for the meta-machine learning model to build the ensemble. Stacking algorithms are generally advantageous when building heterogeneous ensembles.

### Neural Networks

Neural networks, modeled on the human brain, allow for processing of information and machine learning. Neural networks include nodes that mimic the function of individual neurons, and the nodes are organized into layers. Neural networks include an input layer, an output layer, and one or more hidden layers that define connections from the input layer to the output layer. Systems and methods of the invention may include any neural network that facilitates machine learning. The system may include a known neural network architecture, such as GoogLeNet (Szegedy, et al. Going deeper with convolutions, in CVPR 2015, 2015); AlexNet (Krizhevsky, et al. Imagenet classification with deep convolutional neural networks, in Pereira, et al. Eds., Advances in Neural Information Processing Systems 25, pages 1097-3105, Curran Associates, Inc., 2012); VGG16 (Simonyan & Zisserman, Very deep convolutional networks for large-scale image recognition, CoRR, abs/3409.1556, 2014); or FaceNet (Wang et al., Face Search at Scale: 80 Million Gallery, 2015), each of the aforementioned references are incorporated by reference.

Deep learning neural networks (also known as deep structured learning, hierarchical learning or deep machine learning) include a class of machine learning operations that use a cascade of many layers of nonlinear processing units for feature extraction and transformation. Each successive layer uses the output from the previous layer as input. The algorithms may be supervised or unsupervised and applications include pattern analysis (unsupervised) and classification (supervised). Certain embodiments are based on unsupervised learning of multiple levels of features or representations of the data. Higher level features are derived from lower level features to form a hierarchical representation. Those features are preferably represented within nodes as feature vectors. Deep learning by the neural network includes learning multiple levels of representations that correspond to different levels of abstraction; the levels form a hierarchy of concepts. In some embodiments, the neural network includes at least 5 and preferably more than ten hidden layers. The many layers between the input and the output allow the system to operate via multiple processing layers.

Within the network, nodes are connected in layers, and signals travel from the input layer to the output layer. Each node in the input layer may correspond to a respective one of the features from the training data. The nodes of the hidden layer are calculated as a function of a bias term and a weighted sum of the nodes of the input layer, where a respective weight is assigned to each connection between a node of the input layer and a node in the hidden layer. The bias term and the weights between the input layer and the hidden layer are learned autonomously in the training of the neural network. The network may include thousands or millions of nodes and connections. Typically, the signals and state of artificial neurons are real numbers, typically between 0 and 1. Optionally, there may be a threshold function or limiting function on each connection and on the unit itself, such that the signal must surpass the limit before propagating. Back propagation is the use of forward stimulation to modify connection weights, and is sometimes done to train the network using known correct outputs. See WO 2016/182551, U.S. Pub. 2016/0174902, U.S. Pat. 8,639,043, and U.S. Pub. 2017/0053398, each incorporated by reference.

Deep learning is part of a broader family of machine learning methods based on learning representations of data. An observation can be represented in many ways such as a vector of intensity values per pixel, or in a more abstract way as a set of edges, regions of particular shape, etc. Those features are represented at nodes in the network. Preferably, each feature is structured as a feature vector, a multi-dimensional vector of numerical features that represent some object. The feature provides a numerical representation of objects, since such representations facilitate processing and statistical analysis. Feature vectors are similar to the vectors of explanatory variables used in statistical procedures such as linear regression. Feature vectors are often combined with weights using a dot product in order to construct a linear predictor function that is used to determine a score for making a prediction.

The vector space associated with those vectors may be referred to as the feature space. In order to reduce the dimensionality of the feature space, dimensionality reduction may be employed. Higher-level features can be obtained from already available features and added to the feature vector, in a process referred to as feature construction. Feature construction is the application of a set of constructive operators to a set of existing features resulting in construction of new features.

For example, a convolutional neural network (CNN) is a class of deep neural network generally designed for two-dimensional image inputs in which a signal travels from the input layer through hidden layers comprising “convolutional layers” and “fully connected layers” to the output layer. In the input layer, each pixel from a signal is mapped to a node. The input layer is connected to a convolutional layer. In a convolutional layer, each node is “sparsely connected”, that is connected to only a sub-matrix of nodes from the previous layer. The connection between the submatrix of nodes and the convolutional layer is subject to a bias term as a set of weights designed detect a given feature in the input. The submatrix and weights together are known as a “filter,” “kernel,” or “feature detector”. For a given convolutional layer, each filter is the same size and shape and applies the same set of weights. Each node in the convolutional layer is provided a summary of the weighted information from the filter as a scalar dot product. The filters are staggered from one another and may overlap such that each node in convolution layer provides a weighted summary for a different sub-matrix from the previous layer. A threshold function may be applied to each node in the convolution layer to determine whether the node will propagate the information from the filter, a function known as “squashing.”

Sliding the filter systematically across the entire input allows the filter to discover a given feature anywhere in the input. The function of sliding the filter over entire image can be controlled by the number of nodes over which the filter movies, known as the “stride” of the convolutional layer. The stride determines the distance that each filter is staggered from adjacent filters and the degree of overlap between filters. The final two-dimensional array of dot products of the convolutional layer is known as the “convolved feature,” “activation map,” or “feature map.”

Filters may also have a given depth. For example, color images have multiple channels, typically one for each color channel, such as red, green, and blue. This means that a single color image provided as an input to the input layer is, in fact, three images. A filter must always have the same number of channels as the input, referred to as “depth”. If an input image has 3 channels (e.g. a depth of 3), then a filter applied to that image must also have 3 channels (e.g. a depth of 3). In this case, a 3×3 filter would in fact be 3×3×3 or [3, 3, 3] for rows, columns, and depth. Regardless of the depth of the input and depth of the filter, the filter is applied to the input using a dot product operation which results in a single value. This means that if a convolutional layer has 32 filters, these 32 filters are not just two-dimensional for the two-dimensional image input, but are also three-dimensional, having specific filter weights for each of the three channels. Each filter results in a single feature map.

Different filters produce different feature maps. A convolutional layer may apply a different filter depending on the given input, with the types of filters available learned during training of the network. For example, the network may be trained to apply filters for a specific task the network is trained to resolve, such as detecting whether an input image contains a vertical line. The convolution layer may be trained to apply any number of possible filters to an input image, for example from 32 to 512 filters.

In some instances it may also be convenient to “pad” an input to a convolutional layer with zero values around the border of the input, a process known as zero-padding. Zero-padding allows the size of feature maps to be controlled. This can allow for the feature map to remain the same size as the input through multiple layers of the CNN. The function of adding zero-padding is known as “wide-convolution” versus “narrow convolution” when no zero-padding is added.

The use of multiple convolutional layers in the network allows for hierarchical decomposition of the input. Convolutional filters that operate directly on input values may learn to extract low level features, such as lines. Convolutional filters that operate on the output from earlier convolution layers may learn to extract features that are combinations of lower-level features, such as features that comprise multiple lines to express shapes.

A CNN may also comprise nonlinear layers (ReLU) and/or pooling or sub sampling layers. A ReLU layer receives a feature map and replaces any negative values in the feature map with a zero. The purpose of the ReLU layer is to introduce non-linearity into the CNN and is advantageous when the input data that the CNN is expected to learn and identify is non-linear. The non-linear output map from a ReLU is known as a “rectified” feature map. A pooling layer reduces the size of the feature map or rectified feature map through dimensionality reduction in a process known as “spatial pooling,” “subsampling,” or downsampling.” For example, each node in a pooling layer may be connected to a sub-matrix of nodes from a convolution or ReLU layer. Each node in the pooling layer may then provide, for example, only the highest value, average of, or sum of the values in each submatrix. Pooling layers can be advantageous to make input representations smaller and more manageable, reduce the number of parameters and computations in the network, reduce the impact of distortions in the input image, and help scale representation of the image. This may reduce training time and control overfitting in the CNN.

The final output from the convolutional, ReLU, and/or pooling layers, is provided to a fully connected layer. The fully connected layers operate under the same principles as a traditional neural network. In a fully connected layer each node in the layer is connected to all of the nodes in a previous layer and all of the nodes in a succeeding layer. The purpose of a fully connected layer is to classify the features extracted by the convolutional layers, for example using single vector machines (SVM).

Backpropagation in CCNs involves adjusting the weights of filters based on the error rate of the CNN, known as “loss.” During backpropagation, the CNN determines the estimated loss at every node in each convolutional layer and adjusts filter weights accordingly to minimize loss. A CNN may be trained by multiple rounds of backpropagation.

A deconvolutional neural network (DNN) is another class of deep neural network designed to generate an image from a feature map or from the output from a CNN. A DNN learns and makes predictions as to the pooling, ReLU, and convolution layers that a feature map may have undergone and performs the opposite function, e.g.. unpooling and deconvolution.

### Incorporation by Reference

References and citations to other documents, such as patents, patent applications, patent publications, journals, books, papers, web contents, publicly accessible databases, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A system for training and assisting help line responders, the system comprising:
a database comprising:
data from previous interactions between help line users and help line responders, the interactions comprising help line user communications and help line responder communications, and
efficacy scores for help line responder communications calculated from each previous interaction;
a training module developed from the database configured to:
output simulated help line user communications to trainees;
evaluate the effectiveness of help line responder communications; and/or
provide recommended responses to help line responders.

2. The system of claim 1, wherein the module is configured to:
output simulated help line user communications to a trainee, and
evaluate the effectiveness of help line responder trainee communications to the simulated help line user communications.

3. The system of claim 1, wherein the module is configured to:
evaluate the effectiveness of help line responder communications to help line user communications; and
provide recommended responses for help line responders to provide to help line users' communications, in real-time.

4. A system for help line risk assessment, the system comprising:
a database comprising:
data from previous interactions between help line users and help line responders, the interactions comprising help line user communications and help line responder communications, and
intensity scores for previous interactions based on help line user communication and help line responder communications;
a machine learning module trained on the database, the machine learning module configured to assign an intensity score to interactions based on user communications and/or responder communications.

5. The system of claim 4, wherein the system is configured to provide an alert to a help line responder and/or supervisor of the help line responder based on an assigned intensity score.

6. The system of claim 5, further comprising an assignment module which receives help line responder preferences regarding interaction intensity.

7. The system of claim 6, wherein the assignment module receives help line responder preferences in real time.

8. The system of claim 7, wherein help line responder preferences may be automatically generated.

9. The system of claim 8, wherein help line responder preferences are automatically generated based on the intensity score of a responder's previous interactions with the system.

10. The system of claim 9, wherein the help line responder preferences are generated based on the intensity score of the responder's previous 1-5 interactions.

11. The system of claim 8, wherein when the system receives help line user communications then the assignment module receives an intensity score for the interaction from the machine learning module based on the help line user communications and assigns the help line user to a help line responder based on the help line responder's preferences.

12. The system of claim 5, further comprising an assignment module which receives help line responder attributes.

13. The system of claim 9, wherein help line responder attributes include professional clinical social work or psychological experience or supervisory experience or staff or volunteer experience.

14. A system for help line assessment, the system comprising:
a database comprising:
data from previous interactions between help line users and help line responders, the interactions comprising help line user communications and help line responder communications,
categories for help line interactions;
categorizations into the categories for previous interactions based on help line user communications, help line user inputs, help line responder communications, and help line responder inputs;
a machine learning module trained on the database, the machine learning module configured to assign interactions into one or more categories based on user communications and/or responder communications.

15. The system of claim 14, further comprising an assignment module which receives help line responder preferences regarding categories for help line interactions.

16. The system of claim 15, wherein the assignment module receives help line responder preferences in real time.

17. The system of claim 16, wherein when the system receives help line user communications then the assignment module receives one or more categories for the interaction from the machine learning module based on the help line user communications and assigns the help line user to a help line responder based on help line responder preferences.

18. The system of claim 14, wherein categories for help line interactions include internal characterizations selected from the group consisting of prank, testing, non-engaged/nonresponsive, third party, or international, emotional and mental health crises selected from the group consisting of anxiety, depression, eating disorders, emotional abuse, gun violence, loneliness, suicide, and self-harm.

19. The system of claim 14, further comprising an assignment module which receives help line responder attributes.

20. The system of claim 19, wherein when the system receives help line user communications then the assignment module receives one or more categories for the interaction from the machine learning module based on the help line user communications and assigns the help line user to a help line responder based on help line responder attributes.

21. The system of claim 1, wherein help line responder attributes include clinical experience, supervisory experience, and experience within a category.

22. The system of claim 4, wherein the system is configured to analyze a plurality of electronic messages from users' devices, and prioritize users in a queue for responses from help line responders based upon their assigned intensity score.
